(19) United States
(12) Patent Application Publication
(10) Pub. No.: US 2001/0027820 A1
(43) Pub. Date: Oct. 11, 2001

(54) Fuel hose and producing method of the same

(76) Inventors: Masahiro Ando, Nishikasugai-gun (JP); Tomohide Aoki, Nishikasugai-gun (JP)

Correspondence Address: PILLSBURY WINTHROP LLP, 1600 TYSONS BOULEVARD, MCLEAN, VA, 22102, US

(21) Appl. No.: 09/732,943

(22) Filed: Dec. 11, 2000

(30) Foreign Application Priority Data
Dec. 9, 1999 (JP) HEI 11-349915

(51) Int. Cl. F16L 11/00

(52) U.S. Cl. 138/137; 138/140; 138/DIG. 7

(57) ABSTRACT

A fuel hose having a resin film layer, which exhibits a satisfactorily good impermeability to fuel, work efficiency in connecting operation, and sealing properties. By using polyamide resin or fluorine-based resin having a tensile strength of 50 MPa or less, elongation at break of 200% or more, flexural modulus of 100 MPa or less as the resin for composing the resin film layer, the obtained fuel hose exhibits improved airtightness, improved flexibility, and can be readily connected.

### BACKGROUND OF THE INVENTION

1. Field of the Invention

The present invention relates to a fuel hose having a laminated structure, which includes a rubber main layer and a resin film layer formed on an inside surface of the rubber main layer, and exhibiting impermeability to fuel, and also relates to a method for producing such fuel hose.

2. Description of Related Art

Conventionally, rubber hoses having good oil resistance have been frequently used as fuel hoses for vehicles. And recently, to reduce the effect on the environment, fuel hoses have been required to exhibit an improved impermeability to fuel. To meet this requirement, fuel hoses, each including a rubber hose and a resin layer that is formed inside the rubber hose and exhibits a low permeability to fuel, such as gasoline, have been put into practical application. For example, it is known to form a fuel hose by fitting a previously prepared polyamide-based resin tube inside a rubber hose. It is also known to form a fuel hose by applying a resin powder, such as a fluorine-based resin powder and polyamide resin-blended fluorine-based resin powder, to an inside surface of a rubber outer layer, with an electrostatic coating technique, and heating a resultant resin coat to obtain a resin inner layer. Publications of unexamined patent applications Nos. Hei 6-255004 and Hei 8-25578 disclose such fuel hose configurations.

The fuel hose formed by fitting a previously prepared resin tube, however, has the problem that the thickness of the resin tube is difficult to decrease, so that the flexibility of the fuel hose is low. This fuel hose is also difficult to apply to the rubber hose due to the three-dimensionally curved configuration. On the other hand, the fuel hose formed by an electrostatic coating technique has the problem that a homogeneous resin layer having a predetermined thickness is not readily obtained inside the rubber hose with a good adhesion therebetween. Furthermore, if the resin layer is formed at ends of the fuel hose, as connecting parts to pipes, a great force is needed to enlarge the fuel hose upon connecting the same to pipes, thus requiring troublesome operations. In addition, after connecting the fuel hose, the hard resin inner layer is difficult to conform to irregularities in the periphery of the pipe. This causes degradation of the sealing properties of the fuel hose so that fuel may leak via minute gaps existing between the fuel hose and pipe. Consequently, in order to effect satisfactory work efficiency in connecting the fuel hose and sealing properties, no resin layer can be formed at ends of the fuel hose.

### SUMMARY OF THE INVENTION

Accordingly, it is an object of the present invention to provide a fuel hose wherein a resin layer is uniformly formed on an inside surface of a rubber hose with a good adhesion, which is capable of exhibiting highly satisfactory barrier properties to fuel permeation, work efficiency in connecting to pipes, and sealing properties at connecting parts thereof, and to provide a method for producing such a fuel hose.

In the first aspect of the present invention, a fuel hose includes a main layer of a rubber material, and a resin film layer exhibiting impermeability to fuel, which is formed on an inside surface of the main layer. The resin film layer is composed of a resin having a tensile strength of 50 MPa or less, elongation at break of 200% or more, and flexural modulus of 100 MPa or less.

A resin film layer having these properties exhibits excellent flexibility. When the fuel hose of the present invention is connected to a pipe, the resin film layer can be enlarged comparatively readily without requiring a great force, and can elongate sufficiently without any cracking or the like. Furthermore, the resin film layer can follow the configuration of the outer periphery of the pipe without generating any gaps or the like so as to prevent the leakage of fuel. Consequently, if the resin film layer is also formed at ends of the fuel hose, as connecting parts to pipes, the fuel hose maintains excellent flexibility. Thus, the fuel hose of the present invention has improved barrier properties to fuel permeation, work efficiency in connecting to pipes, and sealing properties so as to exhibit great reliability.

It is preferable that the resin film layer is composed of a resin exhibiting a tensile strength of 10 to 50 MPa, elongation at break of 200 to 500%, and flexural modulus of 30 to 100 MPa. By using the resin exhibiting these physical properties, greater reliability and operational advantages can be obtained.

In is also preferable that the resin film layer is composed of polyamide-based resin or fluorine-based resin. By using these resins, the above-described physical properties can be readily obtained.

The preferred thickness of the resin film layer ranges from 30 to 100 μm. Within this range, the resultant fuel hoses can advantageously exhibit impermeability to fuel as well as flexibility.

In the second aspect of the present invention, a method for producing a fuel hose which includes a main layer of a rubber material and a resin film layer exhibiting impermeability to fuel located on an inside surface of the main layer, is provided. The method includes the steps of introducing a solution of a resin exhibiting impermeability to fuel into the interior of the main layer to form a film of the resin solution on the inside surface of the main layer, discharging excess resin solution, and heating the inside surface of the main layer to form the resin film layer.

In the method of the present invention, the resin film with a predetermined thickness can be readily formed on the inside surface of the main layer. The solution of the resin exhibiting impermeability to fuel, of which the temperature, viscosity and the like are properly adjusted, is introduced into the interior of the main layer and subsequently discharged from the interior of the main layer. Since a resin solution is used, a homogeneous film can be readily formed without occurrence of any pinhole, which has been encountered with the powder coating method due to a lack of powder. Additionally, the solvent in the solution permeates the rubber material of the main layer, and resin can be captured thereby, thus enabling adhesion between the main layer and resin film layer to some depth from the interfaces thereof to improve adhering properties. By heating the inside surface of the main layer, the resultant resin film layer adheres to the main layer, thus effecting a fuel hose which exhibits excellent reliability and durability.

In the case of the adhering properties being insufficient or for increased adhering properties, an adhesive may be used. The adhesive treatment includes but is not limited to (i) applying the adhesive to the inside surface of the main layer prior to the formation of the resin film layer; (ii) adding an adhesive component and/or (iii) adding an adhesive component to the rubber material of the main layer, or the solution of resin. Especially, in the case of a resin that would not generate crosslinking in the heating treatment being used, it is preferable to perform at least one of the adhesive treatments identified above.

When the resin being used would not generate crosslinking in the heating treatment, the resin may melt due to heat and degrade the orientation (crystallization) of molecules thereof, thereby decreasing the resin's barrier properties. To overcome this problem, it is preferable to add an adhesive to the solution. With this arrangement, crosslinking occurs in the resin film layer to enhance the barrier properties, thus improving the performance of the fuel hose.

Other objects, features, and characteristics of the present invention will become apparent upon consideration of the following description and the appended claims with reference to the accompanying drawings, all of which form a part of this specification.

### BRIEF DESCRIPTION OF THE DRAWINGS

FIG. 1 is a longitudinal sectional view of a fuel hose in accordance with the present invention; and

FIG. 2(a), FIG. 2(b), FIG. 2(c) and FIG. 2(d) are longitudinal sectional views, depicting the process for producing a fuel hose in accordance with the present invention.

### DETAILED DESCRIPTION OF THE PREFERRED EMBODIMENTS

Hereinafter, one embodiment of the present invention will be explained with reference to the drawings.

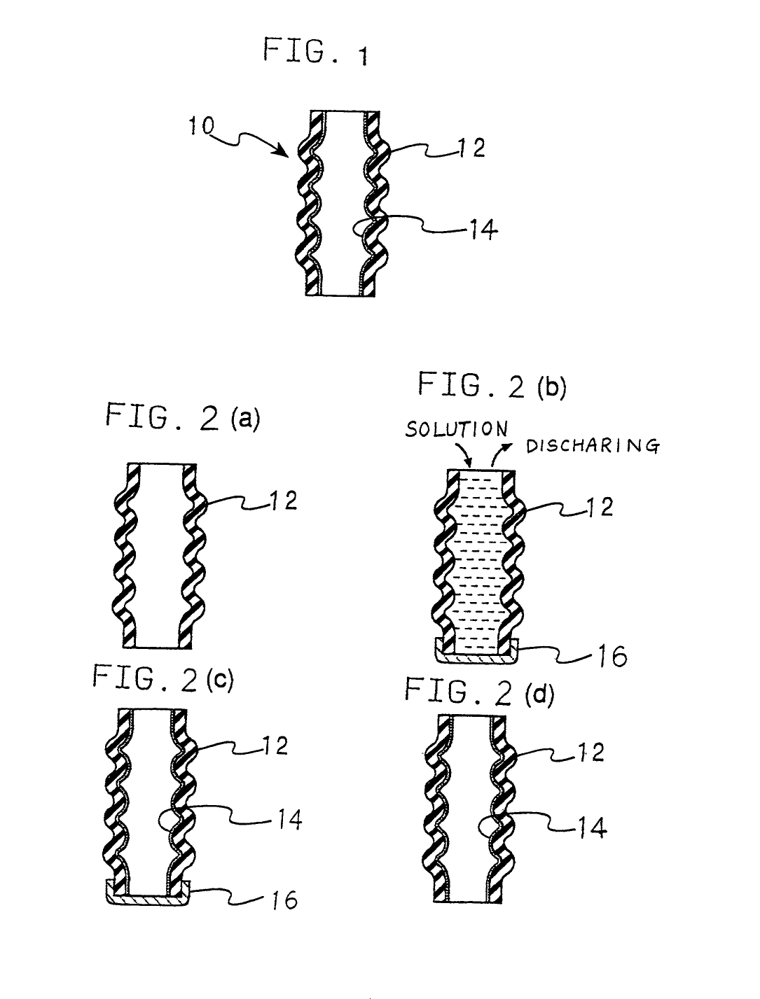

As illustrated in FIG. 1, the fuel hose 10 has a laminated structure, and includes a main layer 12 composed of a rubber material, and a resin film layer 14 which is formed on an inside surface of the main layer 12. The main layer 12 is composed of a rubber material normally used as a fuel hose. A blend rubber of acrylonitrile-butadiene copolymer rubber (NBR) and polyvinylchloride (PVC), epichlorohydrin rubber or the like is preferred. The configuration of the main layer 12 is not limited specifically. Various configurations such as the bellowlike configuration (except for axial ends) which is illustrated in FIG. 1, cylindrical tube-like configuration and curved tube-like configuration will do. The diameter and thickness of the main layer 12 may be arbitrarily selected in accordance with the use thereof. In the case of the fuel hose for vehicle, for example, the preferred diameter may normally range from about 20 to about 40 mm, and the preferred thickness may normally range from about 3 to about 5 mm.

The resin film layer 14 is composed of the resin which exhibits an excellent impermeability to fuel, resistance to fuel, and high flexibility. These properties can be effected by using a resin which has a tensile strength of 50 MPa or less, elongation at break of 200% or more, and flexural modulus of 100 MPa or less. In a preferred embodiment, the resin as a tensile strength of 10 to 50 MPa, elongation at break of 200 to 500%, and flexural modulus of 30 to 100 MPa. When the tensile strength is less than 10 MPa, and the elongation at break is less than 200% the resin film layer 14 may be broken upon bending of the hose, for example. On the other hand, when the flexural modulus is greater than 100 MPa, good sealing properties cannot be effected. In order to form a homogeneous film in the resin film layer 14, it is preferable to apply the resin in a solution state to the main layer 12, as described later. In this case, it is preferable to use a resin soluble in an alcohol, ester, or ketone solvent or like solvents.

Examples of resins for composing the resin film layer 14 include polyamide, fluorine and polyacetal-based resins. More specifically, a modified polyamide resin such as nylon 6 resin having alkoxyalkyl groups in side chains thereof, ternary fluorine-based resin such as tercopolymer of vinylidene trifluoride, propylene hexafluoride and ethylene tetrafluoride (THV, ex.) are preferably used.

The resin film layer 14 may be composed of the resin which exhibits the above-described physical properties, which is arbitrarily selected from these resins.

Normally, the preferred thickness of the resin film layer 14 ranges from 30 μm to 100 μm. When the thickness of the resin film layer 14 is 30 μm or more, satisfactory impermeability to fuel and resistance to fuel oil can be effected. When the resin fil, layer's thickness is 100 μm or less, the flexibility is enhanced to improve the work efficiency in connecting the fuel hose to the pipe, and the airtightness of the fuel hose can be improved.

When the resin film layer 14 is composed of a fluorine-based resin, it is preferable to add an adhesive component to the resin solution for composing the resin film layer 14. When a fluorine-based resin solution that would not generate crosslinking in the heating step is applied to the main layer 12, dried, and heated for forming the resin film, the crystallization thereof may degrade to decrease the barrier properties to fuel. By adding the adhesive component to the resin solution, good barrier properties can be effected.

It is more preferable to form an adhesive layer between the main layer 12 and resin film layer 14. To form the adhesive layer, an adhesive may be applied to the inside surface of the main layer 12 prior to applying the resin. With this arrangement, the adhesion between the main layer 12 and resin film layer 14 can be enhanced. The preferred examples of the adhesive for composing the adhesive layer include an amine adhesive such as a ketimine compound. Examples of the adhesive component to be added to the resin solution include an adhesive component of the amine adhesive or the like.

Otherwise, the rubber material for composing the main layer 12 may previously contain some adhesive component such as a salt of organic phosphonium and the like.

The preferred content of the adhesive component is normally about several % of the weight of the polymer. Alternatively, an additive normally added to rubber may be added to the rubber material for composing the main layer 12.

The method for producing fuel hoses having the above-described arrangement will be explained with reference to FIGS. 2(a) to 2(d). First, some adhesive component or the like is added to the rubber material for composing the main layer 12, as required, and the main layer 12 having the configuration illustrated in FIG. 2(a), for example, is formed by well known injection molding and extrusion. Next, the inside surface of the main layer 12 is subjected to one or more of the following treatments, as required: \mathring{1} cleaning with a neutral detergent such as alkylbenzene sulfonic acid, \mathring{2} immersing in an acid aqueous solution of pH 3 or more (acidification), and/or \mathring{3} roughening by shot blasting. With one or more treatments, the adhesion between the main layer 12 and resin film layer 14 can be enhanced.

In the case where the resin film layer 14 is fluorine-based resin, and the rubber material for composing the main layer 12 does not contain any adhesive component, it is preferable to apply an adhesive to the inside surface of the main layer 12 in addition to the above-described treatments. The above-described amine adhesive or the like is the preferred adhesive. Alternatively, in the process illustrated in FIG. 2(b), about several % by weight of the above-described adhesive component of the amine adhesive or the like may be added to the resin solution composing the resin film layer 14. At least one of the above-described three treatments is needed.

In the process illustrated in FIG. 2(b), the resin solution for composing the resin film layer 14 is applied to the inside surface of the main body 12. In this step, the resin for composing the resin film layer 14 is dissolved as a solute in a solvent to form the resin solution. Examples of the solvent may include one or more kinds of alcohol solvents such as ethanol, methanol and isopropylalcohol, ester solvents such as butyl acetate and ethyl acetate, and ketone solvents such as methyl ethyl ketone and methyl isobutyl ketone. The method for applying the resin solution is carried out, for example, as illustrated in FIG. 2(b), by closing one end (lower end) of the main layer 12 with a stopper 16, pouring the resin solution into the main layer 12 from an upper open end until the main layer 12 is filled with the resin solution up to the upper edge thereof, and discharging the resin solution. Thus, as illustrated in FIG. 2(c), a film of the resin solution can be readily formed on the inside surface of the main layer 12 to define the resin film layer 14.

The preferred concentration of the resin solution normally ranges from 10 to 30% by weight in the case of the resin being polyamide-based resin, and normally ranges from 5 to 20% by weight in the case of the resin being fluorine-based resin. The preferred viscosity of the solution is about 320 Pa·s or less by measuring with a rotational viscometer in the case of the resin being polyamide-based resin, and about 60 cp or less by measuring with a B-type viscometer in the case of the resin being fluorine-based resin. Within these ranges of concentration and viscosity, the resin solution can exhibit a sufficient fluidity to enable the formation of a homogeneous resin film layer 14 having a required film thickness.

Alternatively, the resin solution may be applied to the inside surface of the main layer 12 by introducing the resin solution from a lower open end to fill the interior of the main layer with the solution, and discharging the solution therefrom. With this method, a homogeneous resin film layer can be readily formed over the entire inside surface of the main layer. The method for applying the resin solution is not limited to these methods.

Other methods may be used as long as the resin film layer is formed on the inside surface of the main layer using the above solutions. The interior of the main layer need not be fully filled with the resin solution as long as the resin solution spreads over the entire inside surface of the main layer. This can be accomplished by rotating the main layer or other method, after introducing a required amount of resin solution.

Next, the main layer 12 on which the resin film layer 14 is formed is subjected to the drying treatment to evaporate the solvent within the resin solution. The drying temperature and drying time depend on the solvent. In the case of an alcohol solvent, the drying treatment is carried out at the temperature from 60 to 90° C. for about 10 to 20 minutes. In the case of an ester or ketone solvent, after the temperature is gradually raised from room temperature, the drying treatment is carried out at a temperature from 80° C. to 100° C. for about 5 minutes to evaporate the solvent. The step of applying the resin solution may be carried out such that a desired film thickness ranging from 30 μm to 100 μm is obtained in a single step. The film thickness is adjusted with the concentration and temperature of the resin solution. Normally, the temperature is properly adjusted between 35° C. and 55° C. The film thickness need not necessarily be adjusted to the desired thickness in a single applying step.

When the desired thickness is not obtained in a single step, after drying the resultant resin film, the step of applying the resin solution may be repeated until the desired film thickness is obtained.

Next, in order to improve the adhesion further, the heating treatment is carried out. Thus, as illustrated in FIG. 2(d), a fuel hose 10 having the resin film layer 14 on the inside surface of the main layer 12 is obtained. The heating temperature ranges from 120° C. to 170° C., for example, and the heating time ranges from about 3 minutes to about 5 minutes, for example. Where a polyamide-based resin is used to form the resin film layer 14, crosslinking occurs in the heating treatment and the resin adheres to the rubber material as the base material of the main layer 12.

Where the resin composing the resin film layer 14 is a fluorine-based resin, the fluorine-based resin is melted to adhere to the main layer 12. Upon melting, the fluorine-based resin is bonded to the main layer 12 via the adhesive layer, or by the action of the adhesive component included in the rubber material or resin solution. Accordingly, the heating temperature which enables the melting of fluorine-based resin is needed and it is preferable to use a fluorine-based resin having a comparatively low melting point, such as 150° C. or less.

The resin film layer 14 has excellent flexibility. So, where the resin film layer 14 is formed in the connecting parts at longitudinal ends of the main body 12, the resin film layer 14 does not degrade the work efficiency in connecting operations or sealing properties, unlike a conventional fuel hose. Since the resin film layer 14 can be formed in the connecting parts located at longitudinal ends of the fuel hose, fuel hose production is facilitated. The resin film layer 14 can be readily formed by a simple method of filling the interior of the main body 12 with the resin solution and discharging the same therefrom. In addition, since the resin in the solution state is used, the obtained resin film layer 14 is homogeneous and exhibits high adhesion and improved barrier properties. Thus, the fuel hose 10 having an improved impermeability to fuel, resistance to fuel, work efficiency and sealing properties is produced.

### EXAMPLE 1

A fuel hose having a resin film layer 14 on the inside surface of a main layer 12 was produced in the processes illustrated in 2(a) to 2(d). The rubber material for composing the main layer 12 includes as the base material a blend rubber of acrylonitrile-butadiene copolymer rubber (NBR) and polyvinylchloride (PVC). The composition of the rubber material is shown in Table 1. The rubber material was molded, using an injection molding machine, into a bellow-like configuration having an inside diameter at longitudinal ends of 24.4 mm, thickness of 5 mm and length of 250 mm, and vulcanized at 170° C. for 2 minutes.

TABLE 1
COMPOSITION (PART BY WEIGHT)

| | |
|---|---|
| NBR/PVC*¹⁾ | 100 |
| SRF BLACK | 100 |
| PLASTICIZER | 50 |
| STEARIC ACID | 1 |
| ZINC OXIDE | 5 |
| ANTIOXIDANT | 7 |
| SULFUR | 0.5 |
| VULCANIZATION ACCELERATOR | 4 |

*¹⁾NBR/PVC = 70/30

The inside surface of the main layer 12 was subjected to a cleaning treatment with alkylbenzene sulfonic acid, and then the lower end of the main layer 12 was sealed tightly. Nylon 6 having alkoxyalkyl groups in side chains thereof, which has a tensile strength of 50 MPa or less, elongation at break of 200% or more and flexural modulus of 100 MPa or less, was used as the resin for composing the resin film layer 14. Nylon 6 was dissolved in ethanol as the solvent to obtain the solution having a concentration of 20% by weight. The viscosity of the solution was 317 mPa·s, and the temperature thereof was 35° C. The interior of the main layer 12 was filled with this solution, and then the solution was discharged immediately to form a film of the solution on the inside surface of the main layer 12, thus obtaining the resin film layer 14 having the film thickness of 30 um. Next, the resin film layer 14 was dried within a dryer at 60° C. for 10 minutes, and heated within a heater at 150° C. for 5 minutes to cause resin to generate crosslinking and adhere to the main layer 12.

The physical properties such as tensile strength, elongation at break and flexural modulus of the obtained fuel hose 10 were measured under the examination conditions of ASTM D638M. The measurement results were shown in Table 2. And the airtightness, flexibility and work efficiency in the connecting operation of the obtained fuel hose 10 were evaluated, as follows. With respect to the airtightness, the fuel hose was connected to the outer periphery of a predetermined pipe, and the connected part was tightened with a clamp from the outside of the fuel hose. Then, the inner pressure of the fuel hose was gradually increased, and the judgement whether air leakage occurred at 40 kPa or less was performed. With respect to the flexibility, the fuel hose was cut to a ring shape having a width of 25 mm, and a radial load was applied to the ring-shaped fuel hose to compress it inwards. Then, the judgement whether the load required to compress the fuel hose to one half of the outside diameter was 0.3 kg or less was performed. With respect to the work efficiency in connecting operation, the fuel hose was connected to the pipe by inserting the pipe into the fuel hose at the rate of 30 mm/min. Then, the force required for insertion was measured, and the judgement whether the required force was 200 N or less was performed. In Table 2, when the above described standards of judgement were sufficiently cleared, the symbol O was indicated, when the standards of judgement were nearly cleared, or not partly cleared due to production scattering, the symbol A was indicated, and when the standards of judgement were not cleared, the symbol X was indicated.

TABLE 2

| | Comparative Example | | Examples of Invention | |
|---|---|---|---|---|
| Tensile strength | 1 | 2 | 1 | 2 |
| (Mpa) | | | | |
| Elongation at | 54 | 20 | 25 | 20 |
| break (%) | | | | |
| Flexural | 270 | 450 | 400 | 500 |
| modulus (Mpa) | | | | |
| Melting Point | 183˜187 | 165˜180 | — | 115˜125 |
| (° C.) | | | | |
| Airtightness | Δ | Δ | ∘ | ∘ |
| Flexibility | X | X | ∘ | ∘ |
| Work | X | X | ∘ | ∘ |
| efficiency in | | | | |
| connecting | | | | |

The adhesion of the fuel hose 10 subjected to the heat treatment was examined. After supplying normal gasoline or alcohol-containing gasoline with the fuel hose, no floating nor peeling was observed therein. Even when the fuel hose 10 was elongated by 50% or more, no floating or peeling therein could be obtained. The amount of fuel permeated the fuel hose 10 per unit area of the inside surface thereof was measured by the SHED DBL method, and the result was 1.2 g/m²·TEST or less, which was preferable.

### EXAMPLE 2

The main layer 12 was formed by injection molding, similarly to Example 1, and the inside surface of the main layer 12 was cleaned with alkylbenzene sulfonic acid. Then, a ketimine compound as the adhesive was applied to the inside surface of the main layer 12. Ternary copolymer (THV) of vinylidene fluoride, propylene 6-fluoride, and ethylene 4-fluoride which has a tensile strength of 50 MPa or less, elongation at break of 200% or more and flexural modulus of 100 MPa or less was used as the resin for composing the resin film layer 14. The solution was prepared by dissolving the ternary copolymer in butyl acetate as the solvent. And, similarly to Example 1, the interior of the main layer 12 was filled with the prepared solution, which was subsequently discharged, thus obtaining the resin film layer 14 on the inside surface of the main layer 12. The concentration of the solution was 5% by weight, viscosity was 30 cps, and temperature was 25° C. The film thickness was 30 μm. Next, the resin film layer 14 was dried within a dryer at 60° C. for 5 minutes, and heated within a heater at 150° C. for 5 minutes to carry out adhering of resin to the main layer 12.

The airtightness, flexibility and work efficiency in connecting operation of the obtained fuel hose 10 were evaluated, and the physical properties such as tensile strength, elongation at break and flexural modulus were measured, similarly to Example 1. The evaluation and measurement results are shown in Table 2, together.

### COMPARATIVE EXAMPLES 1 AND 2

For comparison, fuel hoses were produced, using generally used nylon resin (nylon 11) (Comparative example 1), or fluorine-based resin (THV) of which the flexural modulus is outside that of the present invention (Comparative example 2) as the resin for composing the resin film layer. The resins of Comparative examples 1 and 2 were difficult to take to a solution state. So, in these examples, the resin film layers were formed by applying powder in place of solution. Fuel hoses were prepared by the method similar to Examples 1 and 2, except for the method of forming the resin film layer, and evaluations and measurements of the prepared fuel hoses were performed, similarly to Examples 1 and 2. The evaluation and measurement results are shown in Table 2, together.

Table 2 clearly shows that the fuel hose 10 having the resin film layer 14 in accordance with the present invention, of which the tensile strength is 50 MPa or less, elongation at break is 200% or more and flexural modulus is 100 MPa or less, exhibits good airtightness, flexibility and work efficiency in connecting operation, which are all superior to those of the conventional fuel hose.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. A fuel hose comprising:
a main layer composed of a rubber material, and
a resin film layer having impermeability to fuel, which is formed on an inside surface of said main layer, said resin film layer being composed of a resin having a tensile strength of 50 MPa or less, elongation at break of 200% or more and flexural modulus of 100 MPa or less.

2. The fuel hose as claimed in claim 1, wherein said resin film layer is composed of a resin having a tensile strength of 10 to 50 MPa, elongation at break of 200 to 500% and flexural modulus of 30 to 100 MPa.

3. The fuel hose according to claim 1, wherein said resin film layer is a resin selected from the group consisting of polyamide-based resin, fluorine-based resin and polyacetyl-based resin.

4. The fuel hose according to claim 1, wherein said resin film layer has a film thickness of 30 to 100 μm.

5. A method for producing a fuel hose having a main layer composed of a rubber material, and a resin film layer exhibiting impermeability to fuel, which is formed on an inside surface of the main layer, comprising the steps of introducing a solution of a resin for composing the resin film layer into the interior of the main layer to obtain a film layer of said resin on the inside surface of the main layer;
discharging an excess solution; and
heating said resin film layer.

6. The method according to claim 5, wherein, before introducing said solution into the interior of the main layer, an adhesive is applied to the inside surface of the main layer.

7. The method according to claim 5, wherein, before introducing said solution into the interior of the main layer, an adhesive component is added to one of the rubber material for the main layer, and said solution.

8. The fuel hose according to claim 1, wherein said rubber material of said main layer is one of a blend rubbber of acrylonitrile-butadiene copolymer rubber (NBR) and polyvinylchloride (PVC), and epichlorohydrin rubber.

9. The fuel hose according to claim 1, wherein said resin of said resin of said resin film layer is a resin soluble in one of an alcohol solvent, ester solvent and ketone solvent.

10. The fuel hose according to claim 1, wherein said resin film layer is a resin selected from the group consisting of nylon 6 resin having alkoxyalkyl groups in side chains, vinylidene triflouride, propylene hexaflouride and ethylene tetraflouride

11. The fuel hose according to claim 1, wherein said resin film layer further comprises an adhesive component.

12. The fuel hose according to claim 1, wherein said rubber material of the main layer further comprises an adhesive component.

13. The fuel hose according to claim 11, wherein said adhesive component is an adhesive component of an amine adhesive.

14. The fuel hose according to claim 12, wherein said adhesive component is a salt of organic phosphonium.

15. The fuel hose according to claim 1 further comprising:
an adhesive layer located between said main layer and said resin film layer.

16. The method according to claim 5 further comprising: applying an adhesive to the inside surface of said main layer before introducing said solution in to the interior of the main layer.

17. The method according to claim 5 further comprising: adding an adhesive component to said solution of the resin.

18. The method according to claim 5 further comprising: enhancing adhesion by treating said main layer by one of cleaning with a neutral solution, immersing in an acid, roughening by shot blasting and combinations thereof.

19. The method according to claim 5 further comprising: repeating the introduction of said solution of the resin and discharge of said excess solution of the resin for composing the resin film layer before heating said resin film layer.
